(19) United States
(12) Patent Application Publication
(10) Pub. No.: US 2014/0101024 A1
(43) Pub. Date: Apr. 10, 2014

(54) PREDICTING FINANCIAL OUTCOME

(71) Applicant: SAP AG, Walldorf (DE)

(72) Inventors: Wen-Syan Li, Fremont, CA (US); Tianyu Raymond Luwang, Shanghai (CN)

(73) Assignee: SAP AG, Walldorf (DE)

(21) Appl. No.: 13/644,814

(22) Filed: Oct. 4, 2012

(51) Int. Cl. G06Q 40/02

(52) U.S. Cl. CPC G06Q 40/025
USPC 705/38

(57) ABSTRACT

The embodiments provide a system for predicting financial outcome of an order. The system includes a discriminant model training module configured to receive historical orders from a data source and to generate discriminant model parameters based on the historical orders, a discriminant model engine configured to receive at least one order to be analyzed and to calculate a probability for each of a plurality of outcomes for the at least one order to be analyzed based on the discriminant model parameters, and a strategy comparison module configured to calculate an expected business value for at least one strategy based on, in part, the probabilities for the plurality of outcomes to evaluate a risk associated with the at least one order.

### BACKGROUND

Many companies or individuals may order goods or make purchases based on credit and then make payments at a later time point. For example, an electronic appliance store may place an order of 50 televisions and 100 air conditioners from an appliance manufactory, which may be based on credit. In a typical credit-based order system, each customer (company or individual) may be assigned with a pre-set credit limit over a certain period of time, and the customer may make new purchases or place an order as long as the total amount of purchases or orders during that period do not exceed the credit limit. If the total amount is under the credit limit, the order(s) will be authorized. Otherwise, the order(s) may be blocked until a credit manager with proper authority makes a decision to release the block or disapprove the order(s).

To make such a decision, the credit manager may need to check information related to the customer and/or the order such as a customer profile, historical activities of the customer and similar customers, as well as the contents of the order, in order to make a decision that either authorizes or rejects the credit increase request for this order. The decision may be based on a predicted financial outcome for credit increase over the pre-set credit limit; this is, x dollars of profit or loss by increasing y dollars over a pre-set credit limit l to make a sale of s dollars. If a profit can be made, the credit increase may be granted.

However, the forecasting of historical data related to the outcome of financial transactions using statistical analysis is relatively complex. For instance, this type of forecasting is different than other types such as temperature and sales, which have a number of available algorithms. As such, in the case of determining whether a credit limit should be increased, the conventional methods may not have access to important quantitative information such as comparisons between credit strategies, the degree of risk, and the expected revenue.

### SUMMARY

The embodiments provide a system for predicting financial outcome of an order. The system includes a discriminant model training module configured to receive historical orders from a data source and to generate discriminant model parameters based on the historical orders, a discriminant model engine configured to receive at least one order to be analyzed and to calculate a probability for each of a plurality of outcomes for the at least one order to be analyzed based on the discriminant model parameters, and a strategy comparison module configured to calculate an expected business value for at least one strategy based on, in part, the probabilities for the plurality of outcomes to evaluate a risk associated with the at least one order.

The discriminant model training module configured to generate discriminant model parameters based on the historical orders may include computing new discriminant model parameters during each iteration based on discriminant model parameters of a previous iteration and a change to the discriminant model parameters from the previous iteration.

The discriminant model training module may be configured to calculate the change to the discriminant model parameters from the previous iteration, which may include calculating a negative log likelihood based on, in part, the historical orders, and calculating the change to the discriminant model parameters based on, in part, a function of a gradient of the negative log likelihood. The discriminant model training module may be configured to output the new discriminant model parameters to the discriminant model engine when a current iteration exceeds a maximum iteration or a change in the negative log likelihood from the previous iteration is less than a threshold value.

The discriminant model engine configured to calculate a probability for each of a plurality of outcomes for the at least one order to be analyzed based on the discriminant model parameters may include calculating a probability that the order to be analyzed belongs to each of the plurality of outcomes based on a function corresponding to each outcome supplied with the discriminant model parameters and a feature vector representing one or more attributes of the at least one order to be analyzed.

The strategy comparison module configured to calculate an expected business value for at least one strategy based on, in part, the probabilities for the plurality of outcomes may include calculating an expected business value for each outcome based on a projected business value and the probability associated with a respective outcome, and calculating the expected business value for the at least one strategy based on the calculated expected business value for each outcome.

The expected business value may include expected revenue. The strategy comparison module may be configured to provide the expected business value in conjunction with the at least one strategy for display. The strategy comparison module may be configured to provide, with respect to each outcome for the at least one strategy, a respective projected business value, a respective probability, and a respective expected business value for display. The respective expected business value may be provided based on the respective projected business value and the respective probability.

Each historical order may include a first feature vector representing one or more attributes or features of the historical order, and an outcome vector representing a final outcome of a respective historical order. The at least one order to be analyzed may include a second feature vector representing one or more attributes or features of the at least one order to be analyzed. The first feature vector and the second feature vector may include customer-related features including financial status and contribution of revenue, and order attributes including amount and type of products for a respective order.

The at least one strategy may include acceptance of the order and rejection of the order, and the plurality of outcomes may include on-time payment, overdue payment, and default payment. The at least one order to be analyzed may include a product order for at least one product for which a purchase amount of the at least one product exceeds a credit limit associated with a customer.

The embodiments may include a non-transitory computer-readable medium storing instructions that when executed cause one or more processors to predict financial outcome of an order. The instructions include instructions to receive historical orders from a data source, generate discriminant model parameters based on the historical orders, receive at least one order to be analyzed, calculate a probability for each of a plurality of outcomes for the at least one order to be analyzed based on the discriminant model parameters, and calculate an expected business value for at least one strategy based on, in part, the probabilities for the plurality of outcomes to evaluate a risk associated with the at least one order.

The instructions to generate discriminant model parameters based on the historical orders may include instructions to compute new discriminant model parameters during each iteration based on discriminant model parameters of a previous iteration and a change to the discriminant model parameters from the previous iteration.

The instructions may include instructions to calculate the change to the discriminant model parameters from the previous iteration including calculating a negative log likelihood based on, in part, the historical orders and calculating the change to the discriminant model parameters based on, in part, a function of a gradient of the negative log likelihood, and output the new discriminant model parameters when a current iteration exceeds a maximum iteration or a change in the negative log likelihood from the previous iteration is less than a threshold value.

The instructions to calculate a probability for each of a plurality of outcomes for the at least one order to be analyzed based on the discriminant model parameters may include instructions to calculate a probability that the order to be analyzed belongs to each of the plurality of outcomes based on a function corresponding to each outcome supplied with the discriminant model parameters and a feature vector representing one or more attributes of the at least one order to be analyzed.

The instructions to calculate an expected business value for at least one strategy based on, in part, the probabilities for the plurality of outcomes to evaluate a risk associated with the at least one orders may include instructions to calculate an expected business value for each outcome based on a projected business value and the probability associated with a respective outcome, and calculate the expected business value for the at least one strategy based on the calculated expected business value for each outcome. The expected business value may include an expected revenue.

The embodiments may include a method for predicting financial outcome of an order performed by at least one processor. The method may include receiving, including the at least one processor, historical orders from a data source, generating, including the at least one processor, discriminant model parameters based on the historical orders, receiving, including the at least one processor, at least one order to be analyzed, calculating, including the at least one processor, a probability for each of a plurality of outcomes for the at least one order to be analyzed based on the discriminant model parameters, and calculating, including the at least one processor, an expected business value for at least one strategy based on, in part, the probabilities for the plurality of outcomes to evaluate a risk associated with the at least one order.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating a system for predicting financial outcome of an order according to an embodiment;

FIG. 2 is a flowchart depicting sample process steps of the system of FIG. 1 according to an embodiment;

FIG. 3 is a flowchart for an iterative method for calculating the discriminant model parameters using the system of FIG. 1 according to an embodiment; and

FIGS. 4(a) and (b) illustrate a display of the system of FIG. 1 that provides an expected business value for each strategy and information associated with each outcome according to an embodiment.

### DETAILED DESCRIPTION

Embodiments provide a mechanism that analyzes historical orders to determine discriminant model parameters, and then calculates a probability for a number of different outcomes (e.g., on-time payment, delayed payment, and default) for a new order to be analyzed based on the discriminant model parameters by calculating the probability that the order to be analyzed belongs to a certain outcome. Then, the expected business value for a number of different strategies (e.g., acceptance of the order, rejection of the order) may be calculated and displayed such that a user may access the risk associated with the order. In one embodiment, the mechanism may predict the financial outcome for a credit increase review decision over a pre-set limit, where the output may be an aggregated value of expected revenue/profit or loss as well as their corresponding probability values. A positive aggregated value and the value compared with normal profit if no risk is involved indicate a decision toward approving such credit increase request and vice versa.

As indicated above, the mechanism of the embodiments may analyze historical orders to determine discriminant model parameters. Each historical order may include a plurality of attributes or features such as date, customer identification number, credit limit, used credit, new purchase amount, credit increase requested, decision (Y/N), and/or outcome. In particular, the date is the date on which the sale and credit increase request occurred. The customer identification number may be a number which may be used to access the customer profile. The credit limit may be a pre-set credit limit for the customer, and the used credit may be the credit amount that has been used for un-paid orders/purchases. The new purchase amount may be the amount of the new purchase/order which triggers the request of a credit increase, and the credit increase requested amount may be the (new purchase amount+the used credit)−the credit limit. The decision may indicate if such a credit increase request was granted, and the outcome may be the outcome of the purchase if the credit increase request is granted. The outcome may be recorded as revenue or lose caused by default or delayed payment.

Complications may arise when each of the historic orders is represented as a point in a multi-dimensional space with a value of outcome and customer profile. The prediction of the financial outcome may require comparisons of the new credit increase request with the historic orders along with the considerations of time decay, and factors of the historic data and customer profile. According to the embodiments, the system may employ the use of discriminative models in order to make such a comprehensive quantitative analysis, which may help the credit manager choose the strategy with lower risk and higher revenue.

Generally, a discriminative model may be a type of statistical classification method. For instance, instead of directly assigning a class label to a sample, the statistical classification method may assign the probability that the sample belongs to each type of class (e.g., posterior probability). This probability may be interpreted as the belongingness of the sample to each class. This type of probability may be used in an credit increase approval process to assign a probability to possible outcomes of an order such as “on-time payment”, “overdue payment”, or “default payment” (e.g., the order does not get paid). The probability of “default payment” may be utilized to evaluate the risk of the order. In addition, with the revenue of each outcome, the mathematical expectation of the revenue could be used as a quantitative index to make comparisons between a set of strategies. Then, the credit manager may choose the strategy with highest revenue. These and other features of the embodiments are further discussed below with respect to the figures.

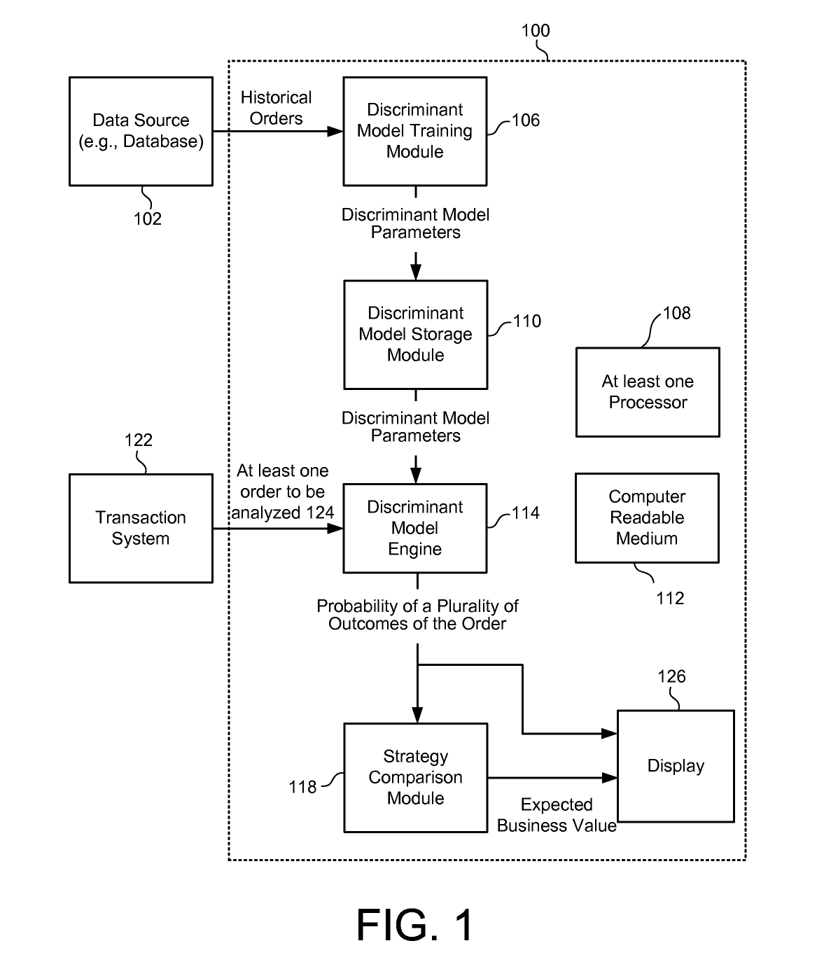

FIG. 1 is a block diagram illustrating a system 100 for predicting financial outcome of an order according to an embodiment. In one embodiment, the system 100 may be a credit management system to evaluate whether an increase in the credit limit to accommodate one or more new orders should be approved. The system 100 may include a discriminant model training module 106, a discriminant model storage module 110, a discriminant model engine 114, and a strategy comparison module 118. The system 100 may be implemented by a computer including at least one processor 108 and a computer readable medium 112 such as a memory or a hard drive storing a computer program product including computer instructions configured to cause the at least one processor 108 to compute the probability of a plurality outcomes of an order and an expected business value for a plurality of strategies, as well as any other functionalities associated with the system 100 discussed herein.

According to the embodiments, the discriminant model training module 106 may receive historical orders from a data source 102 and generate discriminant model parameters based on a discriminant algorithm. The data source 102 may include one or more databases that stores the historical orders associated with customers of a company or enterprise employing the system 100. Each historical order 104 may include customer-related features and order-specific attributes. The customer-related features may include features related to a customer who placed the order, which may be obtained or derived from a customer profile. Generally, the customer-related features may include any type of feature associated with a customer profile such as a customer identification number, the number of previous orders placed with the company, the financial status of the customer (e.g., the revenue, profit, income, employment, etc.) and contribution of revenue to the company which may be in terms of percentage, revenue, and/or profit. In other words, the contribution of revenue may represent how profitable the customer has been to the company.

Generally, the order-specific attributes of the historical orders may include any type of attribute associated with a previous order placed by the customer. In more detail, the order-specific attributes of each historical order may include a date, customer identification number, credit limit, used credit, new purchase amount, credit increase requested, decision (Y/N), and/or outcome. The date may be the date on which the sale and/or credit increase request occurred. The customer identification number may be a number which may be used to access the customer profile. The credit limit may be a pre-set credit limit for the customer, and the used credit may be the credit amount that has been used for un-paid orders/purchases. The new purchase amount may be the amount of the new purchase/order which triggers the request of a credit increase, and the credit increase requested amount may be the (new purchase amount+the used credit)−the credit limit. The decision may indicate if such a credit increase request was granted, and the outcome may be the outcome of the purchase if the credit increase request is granted. The outcome may be recorded as revenue or lose caused by default or delayed payment.

According to the embodiments, the historical orders may be provided to the discriminant model training module 106 in a format that is recognizable by the discriminant model training module 106. For example, each historical order may be represented by a feature vector having a plurality of numerical values, where each value represents a certain customer-related feature or order specific attribute of the historical order, and an outcome vector that represents a final outcome of a respective historical order. In particular, the feature vector may be defined by a vector xᵢ={20, 100, . . . 50}, and the outcome vector may be defined by a vector yᵢ={1, 0, 0}. Each numerical value in the feature vector xᵢ may represent a different attribute or feature corresponding to one of the customer-related features or order-specific attributes. The outcome vector yᵢ may indicate the final outcome of the historical order i. In one particular example, yᵢ={1,0,0} may indicate that the order i was paid on time, yᵢ={0,1,0} may indicate that the order i was paid with some delay, and yᵢ={0,0,1} may indicate that the order i was a default order. It is noted that the embodiments encompass any type of outcome for a particular order.

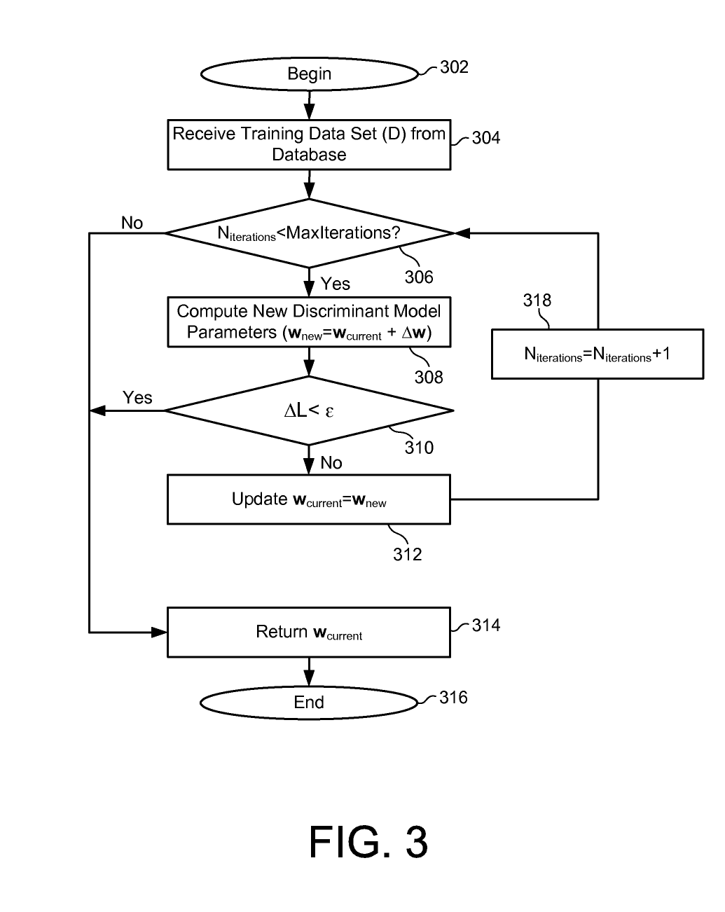

Therefore, according to one embodiment, the discriminant model training module 106 may receive the historical orders in the feature/outcome vector format from the data source 102. According to another embodiment, the discriminant model training module 106 may receive the historical orders from the data source 102, and derive the appropriate feature vectors and outcome vectors for each historical order. In either case, the discriminant model training module 106 may generate the discriminant model parameters based on the historical orders, where each historical order may include the feature vector and the outcome vector. In one example, the discriminant model training module 106 may generate the discriminant model parameters using an iterative process, where w_{new}=W_{current}+Δw. The parameter w_{new} indicates the set of discriminant model parameters for a current iteration that is provided to the discriminant model storage module 110 when the iteration reaches a maximum number of iterations or a specified condition occurs (e.g., ΔL<ε). This condition is further explained with respect to FIG. 3. The parameter w_{current} indicates the discriminant model parameters from a previous iteration (however are the set of current completed set of parameters), and the parameter Δw indicates the change in the discriminant model parameters from the previous iteration. The details of generating the discriminant model parameters are further explained later in the disclosure with reference to FIG. 3.

Then, the discriminant model training module 106 may store the generated discriminant model parameters in the discriminant model storage module 110. The discriminant model storage module 110 may include one or more databases for storing the discriminant model parameters.

The discriminant model engine 114 may receive at least one order to be analyzed 124 from a transaction system 122. The transaction system 122 may include any system for receiving one or more new orders 124 to evaluate a risk associated with each order 124. Similar to the historical orders, each order to be analyzed 124 may include customer-related features and order-specific attributes. Also, the at least one order to be analyzed 124 may include a product order for at least one product for which a purchase amount of the at least one product exceeds a credit limit associated with a customer. However, the at least one order 124 may include any type of order related to the purchase of goods or products.

The customer-related features may include features related to a customer who placed the at least one order 124, which may be obtained or derived from a customer profile. Generally, the customer-related features may include any type of feature associated with a customer profile such as a customer identification number, the number of previous orders placed with the company, the credit limit, used credit, the financial status of the customer (e.g., the revenue, profit, income, employment, etc.) and contribution of revenue to the company which may be in terms of percentage, revenue, and/or profit. In other words, the contribution of revenue may represent how profitable the customer has been to the company. Also, the order-specific attributes of the order to be analyzed 124 may include any type of attribute associated with a current order including the total amount of the order, the customer identification number, and the type of ordered products, for example.

According to one embodiment, the discriminant model engine 114 may receive the order to be analyzed 124 from the transaction system 122 in a format recognizable by the discriminant model engine 114. For example, the order to be analyzed 124 may be represented as a feature vector having a plurality of numerical values, e.g. the feature vector of order i may be xᵢ={20, 100, . . . }. Each numerical value in the feature vector of the order to be analyzed 124 may represent one of the customer-related features and order-specific attributes as discussed above. As such, the discriminant model engine 114 may receive the order to be analyzed 124 in the feature vector format. Alternatively, the discriminant model engine 114 may receive information associated with the order to be analyzed 124, and then derive the appropriate feature vector(s) based on the received information.

Then, the discriminant model engine 114 may calculate a probability for each of a plurality of outcomes for the order to be analyzed 124 based on the discriminant model parameters received from the discriminant model storage module 110. Also, it is noted that the embodiments encompass the situation where the discriminant model engine 114 receives the discriminant model parameters directly from the discriminant model training module 106. In one embodiment, the plurality of outcomes may include “on-time payment”, “delayed payment” and “default.” However, generally, the plurality of outcomes may include a number of different outcomes for a particular order. The type of outcome may depend on the context of the system 100. In the case that the at least one order to be analyzed 124 includes a product order for products that are above a pre-set credit limit, the plurality of outcomes may include the on-time payment, delayed payment, and the default outcome. However, the plurality of outcomes may include other types of outcomes such as the number of times a payment is delayed, varying levels of interest rates, the extent of being delayed, as well as any other outcome related to a purchase order. The discriminant model engine 114 may calculate a probability that the order to be analyzed 124 belongs to each of the outcomes. In one example, the discriminant model engine 114 may compute the probabilities based on a function corresponding to each outcome supplied with the discriminant model parameters and the feature vector of the order to be analyzed 124.

In particular, the discriminant model engine 114 may compute the probability that such order 124 belongs to a particular outcome, e.g., to compute the probability P(C| xᵢ) where xᵢ is the feature vector of order i and C is the outcome of the order (e.g., “in-time payment”, “overdue payment”, and “default payment”). For example, C=0 may indicate that the order will be paid in time, C=1 may indicate that the order will be paid with some delay, and C=2 may indicate that the order will never be paid.

Then, the probability P(C=0| xᵢ)=0.9, P(C=1| xᵢ)=0.06, and P(C=2| xᵢ)=0.04 may indicate that the order i will be paid in time with the probability of 0.9, will be paid with some delay with the probability of 0.06, or will never be paid with probability of 0.04.

In one embodiment, the discriminant model engine 114 may compute the probability P(C| xᵢ) based on the following equations:

$$\begin{matrix}p ( C = 0 \vert {x}_{i} ) = \frac{exp ( {x}_{i}^{T} {w}_{0} + {w}_{00} )}{1 + exp ( {x}_{i}^{T} {w}_{0} + {w}_{00} ) + exp ( {x}_{i}^{T} {w}_{1} + {w}_{10} )} & Eq . ( 1 ) \\ p ( C = 1 \vert {x}_{i} ) = \frac{exp ( {x}_{i}^{T} {w}_{1} + {w}_{10} )}{1 + exp ( {x}_{i}^{T} {w}_{0} + {w}_{00} ) + exp ( {x}_{i}^{T} {w}_{1} + {w}_{10} )} & Eq . ( 2 ) \\ p ( C = 2 \vert {x}_{i} ) = \frac{1}{1 + exp ( {x}_{i}^{T} {w}_{0} + {w}_{00} ) + exp ( {x}_{i}^{T} {w}_{1} + {w}_{10} )} & Eq . ( 3 )\end{matrix}$$

Each of Eqs. (1)-(3) provides a function corresponding to a respective outcome, which is supplied with the feature vector xᵢ of the order to be analyzed, and the discriminant model parameters w₀, w₁, w₀₀ and w₁₀. For example, the parameters w₀ and w₁ are the logistic regression parameters corresponding to the elements of the feature vector xᵢ, and the parameters w₀₀ and w₁₀ are the intercepts. These types of discriminant model parameters may be obtained from the discriminant model parameters from the discriminant model storage module 110/discriminant model training module 106. Then, the discriminant model engine 114 may output the calculated probability for each of the outcomes for a particular order 124 to the strategy comparison module 118 and/or for display 126.

The strategy comparison module 118 may be configured to calculate an expected business value for at least one strategy based on, in part, the probabilities for the plurality of outcomes to evaluate a risk associated with the order 124. In one embodiment, the expected business value may include an expected revenue/profit associated with the order. However, the embodiments may encompass any type of business value that is calculated by the strategy comparison module 118. The at least one strategy may include one or more strategies such as acceptance of the order 124 and/or rejection of the order 124. Also, the strategies may include other types of strategies such as increasing the credit limit, or decreasing the credit limit, or generally, any type of possible decision concerning the order 124. In one example, the strategy comparison module 118 may calculated the expected business value for each strategy using the probabilities calculated by the discriminant model engine 114, which is further explained below.

The strategy comparison module 118 may calculate the expected business value for each strategy based on the expected business values for the respective outcomes of a corresponding strategy. For instance, for each strategy, the strategy comparison module 118 may calculate the expected business value for each outcome, and then sum the expected business values for the outcomes to obtain the expected business value for the respective strategy. In further detail, the strategy comparison module 118 may calculate the expected business value for an outcome using a projected business value and the outcome's calculated probability.

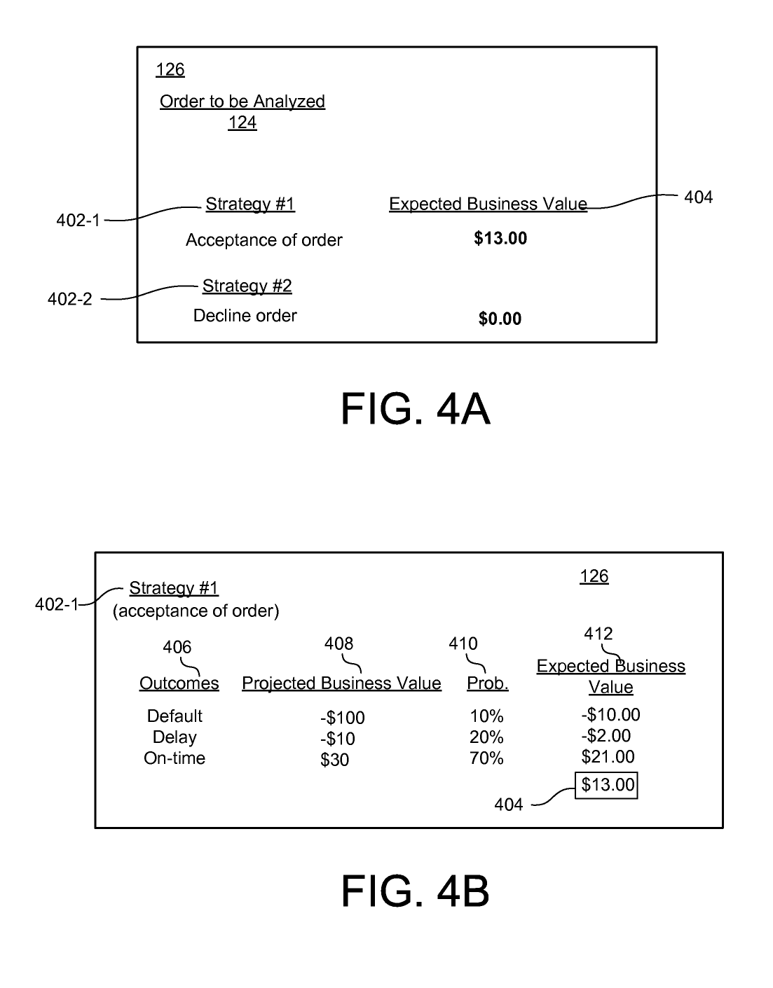

Then, the strategy comparison module 118 may provide expected business value for each strategy on the display 126. Also, the strategy comparison module 118 may provide the expected business value for each strategy, and the discriminant model engine 114 may provide the probabilities of the outcomes, on the display 126. The functionalities of the strategy comparison module 118 may be further explained with reference to FIGS. 4(a) and (b).

FIG. 4(a) illustrates the display 126 that provides the expected business value 404 for each strategy 402 associated with the order to be analyzed 124 according to an embodiment. FIG. 4(b) illustrates the display 126 that provides information (406, 408, 410, 412, and 404) associated with the plurality of outcomes with respect to a particular strategy (402-1) according to an embodiment. Referring to FIG. 4(a), the strategy comparison module 118 may be configured to provide the expected business value 404 in conjunction with each strategy 402-1. In this example, the strategies 402 include a first strategy 402-1 relating to acceptance of the order 124 and a second strategy 402-2 relating to rejection of the order (decline). As shown in FIG. 4(a), each strategy 402 may be associated with an expected business value 404, which may be the expected profit/revenue. In this specific example, the acceptance of the order 124 is expected to generate $13.00 in profit or revenue, whereas the rejection of the order is expected to generate $0.0. The calculation of the expected business values 404 based on the probabilities received from the discriminant model engine 114/discriminant model storage module 110 is further explained with reference to FIG. 4(b).

Referring to FIG. 4(b), the strategy comparison module 118 may be configured to provide, with respect to each outcome 406 of a particular strategy (e.g., 402-1), a respective projected business value 408, a respective probability 410, and a respective expected business value 412. For example, the display 126 may provide the plurality of outcomes such as default, delay, and on-time, and their associated probabilities 410. With respect to default, it may be determined that the projected business value 408 is a loss of $100. For example, the strategy comparison module 118 may compute the projected business value 408 based on the order 124, which, in this case, if the amount of the order is $100, the strategy comparison module 118 may compute a loss of $100 if the customer defaults on his/her obligations. However, the strategy comparison module 118 may encompass any type of technique for computing the projected business value 408 that is well known to one of ordinary skill in the art. According to the embodiments, the strategy comparison module 118 may compute the expected business value 412 for the default outcome (−$10) based on the respective probability 410 (e.g., 10%) and the projected business value 408 (−$100), e.g., by multiplying 0.10 by −100 to obtain −$10.00.

Similar to the default option, the strategy comparison module 118 may compute the expected business value 412 for the delay outcome (−$2) and the on-time outcome ($21) based on its respective probability 410 and projected business value 408. As such, the expected business value 404 for the first strategy 402-1 may be calculated based on the expected business values 412 for the outcomes 406, e.g., by adding the expected business values 412 to obtain $13.00. Therefore, a credit manager or other user of the system 100 may review the expected business value 404 associated with each strategy 402 in order to evaluate the risk of the order 124. In this particular case, because the expected business value 404 is a positive number, the user may be more inclined to follow the first strategy 402-1 (accept the order). In addition, a user may view the more detailed information, as shown with respect to FIG. 4(b), such as the probabilities 410 for each outcome, as well as the expected business value 412 for each outcome for a particular strategy 402.

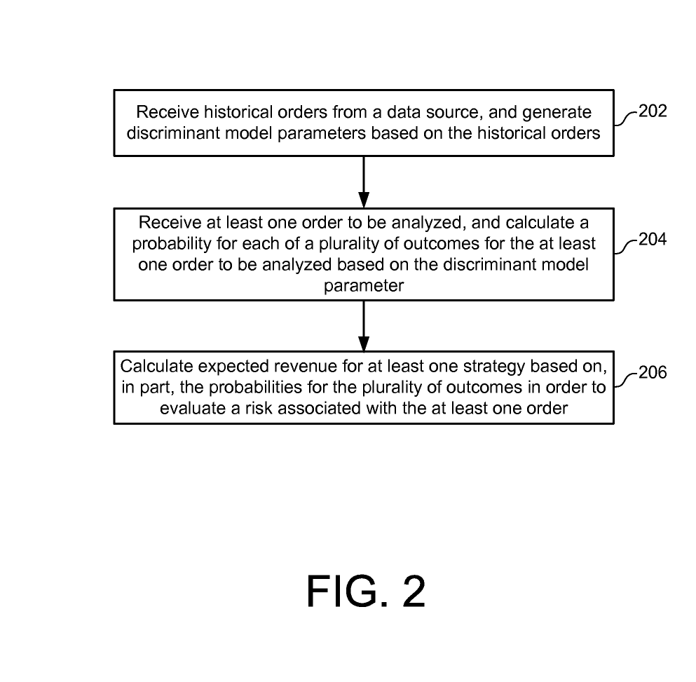

FIG. 2 is a flowchart depicting sample process steps of the system 100 of FIG. 1 according to an embodiment. Although FIG. 2 is illustrated as a sequential, ordered listing of operations, it will be appreciated that some or all of the operations may occur in a different order, or in parallel, or iteratively, or may overlap in time.

Historical orders may be received from a data source, and discriminant model parameters may be generated based on the historical orders (202). For example, referring to FIG. 1, the discriminant model training module 106 may be configured to receive historical orders from the data source 102, and generate the discriminant model parameters based on the historical orders. Each historical order may include customer-related features and order-specific attributes. According to the embodiments, the historical orders may be provided to the discriminant model training module 106 in a format that is recognizable by the discriminant model training module 106. In one example, each historical order may be represented by a feature vector having a plurality of numerical values, where each value represents a certain feature or attribute of the historical order, and an outcome vector that represents a final outcome of a respective historical order. In particular, the feature vector may be defined by a vector xᵢ={20, 100, . . . , 50}, and the outcome vector may be defined by a vector yᵢ={1, 0, 0}. Each numerical value in the feature vector xᵢ may represent a different attribute or feature corresponding to one of the customer-related features or order-specific attributes. The outcome vector yᵢ may indicate the final outcome of the historical order i.

Therefore, according to one embodiment, the discriminant model training module 106 may receive the historical orders in the feature/outcome vector format from the data source 102. According to another embodiment, the discriminant model training module 106 may receive historical orders from the data source 102, and derive the appropriate feature vectors and outcome vectors for each historical order. In either case, the discriminant model training module 106 may generate the discriminant model parameters based on the historical orders, where each historical order includes the feature vector and the outcome vector.

Referring back to FIG. 2, at least one order to be analyzed may be received, and a probability for each of a plurality of outcomes for the at least one order to be analyzed may be calculated based on the discriminant model parameters (204). For example, referring to FIG. 1, the discriminant model engine 114 may receive at least one order 124 from the transaction system 122, and calculate a probability for each of a plurality of outcomes for the at least one order to be analyzed 124 based on the discriminant model parameters. Similar to the historical orders 104, each order to be analyzed 124 may include customer-related features and order-specific attributes. The customer-related features may include features related to a customer who placed the order 124, which may be obtained or derived from a customer profile.

According to one embodiment, the discriminant model engine 114 may receive the order to be analyzed 124 from the transaction system 122 in a format recognizable by the discriminant model engine 114. For example, the order to be analyzed 124 may be represented as a feature vector having a plurality of numerical values, e.g. the feature vector of order i may be xᵢ={20, 100, . . . }. Each numerical value in the feature vector of the order to be analyzed 124 may represent one of the customer-related features and order-specific attributes as discussed above. As such, the discriminant model engine 114 may receive the order to be analyzed 124 in the feature vector format. Alternatively, the discriminant model engine 114 may receive information associated with the order to be analyzed 124, and then derive the appropriate feature vector based on the received information.

Then, the discriminant model engine 114 may calculate a probability for each of a plurality of outcomes for the order to be analyzed 124 based on the discriminant model parameters received from the discriminant model storage module 110. In one embodiment, the plurality of outcomes may include “on-time payment”, “delayed payment” and “default.” As such, the discriminant model storage module 110 may calculate a probability that the order to be analyzed 124 belongs to each of the outcomes. In one example, the discriminant model engine 114 may compute the probabilities based on a function corresponding to each outcome supplied with the discriminant model parameters and the feature vector of the order to be analyzed 124.

In particular, the discriminant model engine 114 may compute the probability that such order 124 belongs to a particular outcome, e.g., to compute the probability P(C| xᵢ), where xᵢ is the feature vector of order i and C is the outcome of the order (e.g., “in-time payment”, “overdue payment”, and “default payment”). For example, C=0 may indicate that the order will be paid in time, C=1 may indicate that the order will be paid with some delay, and C=2 may indicate that the order will never be paid.

Then, the probability P(C=0| xᵢ)=0.9, P(C=1| xᵢ)=0.06, and P(C=2| xᵢ)=0.04 may indicate that the order i will be paid in time with the probability of 0.9, will be paid with some delay with the probability of 0.06, and will never be paid with probability of 0.04. In one embodiment, the discriminant model engine 114 may compute the probability P(C| xᵢ) based on Eqs. (1)-(3) provided above.

Referring back to FIG. 2, an expected business value for at least one strategy may be calculated based on, in part, the probabilities for the plurality of outcomes to evaluate a risk associated with the at least one order (206). For example, referring to FIG. 1, the strategy comparison module 118 may calculate an expected business value for at least one strategy based on, in part, the probabilities for the plurality of outcomes to evaluate a risk associated with the at least one order 124. In one embodiment, the expected business value may include expected revenue associated with the order. However, the embodiments may encompass any type of business value that is calculated by the strategy comparison module 118. The strategy may include a number of different strategies such as acceptance of the order 124 and rejection of the order 124. Also, the strategies may include other types of strategies such as increasing the credit limit, or decreasing the credit limit. Generally, the strategies may encompass any type of decision concerning the order 124.

FIG. 3 is a flowchart for an iterative method for calculating the discriminant model parameters using the discriminant model training module 106 according to an embodiment. Although FIG. 3 is illustrated as a sequential, ordered listing of operations, it will be appreciated that some or all of the operations may occur in a different order, or in parallel, or iteratively, or may overlap in time.

After the process begins (302), a training data set including the historical orders may be received from the database source 102 (204). For example, the training data set may include the feature vector xᵢ and outcome vector yᵢ of each historical order i. The outcome vector yᵢ may indicate the final outcome of the order i. For example, yᵢ={1,0,0} may indicate that the order i was paid in time, yᵢ={0,1,0} may indicate that the order i was paid with some delay, and yᵢ={0,0,1} may indicate that the order i was a default order. Then, the iterative process starts by determining whether the current iteration (e.g., Nᵢₜₑᵣₐₜᵢₒₙₛ) is less than the maximum number of iterations (e.g., MaxIterations) (306). Generally, the variable Nᵢₜₑᵣₐₜᵢₒₙₛ is a variable indicating the current number of iterations that have taken place. The parameter MaxIterations refers to the predetermined maximum number of iterations, where each iteration may update the discriminant model parameters. In one embodiment, the MaxIterations may be set to a relatively large number such as 2000 or 5000. If the number of current iterations is less than the maximum number of iterations, the process continues to 308, and, if the number of current iterations is equal to or greater than the maximum number of iterations, the current discriminate model parameters (W_{current}) are outputted from the discriminant model training module 106.

Next, new discriminant model parameters may be calculated (308). For example, the discriminant model training module 106 may generate the discriminate model parameters based on the historical orders. In particular, the discriminant model training module 106 may generate the new discriminate model parameters based on the discriminate model parameters (w_{current}) from the previous iteration (which are presently the current discriminate model parameters) and a change (Δw) of the discriminate model parameters from the previous iteration, e.g., by adding W_{current} with Δw. The discriminant model training module 106 may compute the change (Δw) of the discriminate model parameters from the previous iteration discriminant model parameters 108 based on the following equations.

The discriminant model training module 106 may compute a likelihood value l using a likelihood function (Eq. (4)) as follows:

$$l = {\prod }_{i} {( p ( 0 \vert {x}_{i} ) )}^{{y}_{i 0}} {( p ( 1 \vert {x}_{i} ) )}^{{y}_{i 1}} {( p ( 2 \vert {x}_{i} ) )}^{{y}_{i 2}} \qquad Eq . ( 4 )$$

The terms P(0| xᵢ), P(1| xᵢ), and P(2| xᵢ) are the probability scores of three outcomes for order i. The negative log likelihood function L may be defined as the negative of natural logarithm of the likelihood function l:

$$L = - ln l = - {\sum }_{i} ( {y}_{i 0} p ( 0 \vert {x}_{i} ) + {y}_{i 1} p ( 1 \vert {x}_{i} ) + {y}_{i 2} p ( 2 \vert {x}_{i} ) ) \qquad Eq . ( 5 )$$

As such, the discriminant model training module 106 may compute a negative log likelihood value using the negative log likelihood function of Eq. (5). The gradient g of the negative log likelihood is defined as:

$$g = \frac{\partial L}{\partial w} \qquad Eq . ( 6 )$$

Finally, the change (update) Δw to the discriminant model parameters is proportional to a function of the gradient as follows:

g, i.e., Δw=−αf(g) Eq. (7)

The variable α is a step size arrived at through the standard application of line maximization at every iteration of the optimization. In this embodiment, the function f applied to the gradient converts it to a conjugate gradient direction using standard methods from the field of mathematical optimization. As such, the discriminant model training module 106 may compute the change (ΔW) of the discriminate model parameters from the previous iteration based on Eq. (7).

Then, the discriminant model training module 106 may update the discriminant model parameters based on:

w_{new}=w_{current}+Δw. Eq. (8)

Next, a change of the value of the negative log likelihood from the previous iteration to the current iteration (ΔL) is determined as less than a predetermined minimum improvement value, the variable ε (310). For example, the discriminant model training module 106 may determine if the change of the negative log likelihood (ΔL) is less than the predetermined minimum improvement value (ε). If the change of the negative log likelihood (ΔL) is less than the predetermined minimum improvement value (ε), the discriminant model training module 106 outputs the new discriminant model parameters (314). However, if the change of the negative log likelihood (ΔL) is not less than the predetermined minimum improvement value (ε), the discriminant model training module 106 makes the new discriminant model parameters as the current discriminate model parameters (312). Then, the iteration is increased by 1 (Nᵢₜₑᵣₐₜᵢₒₙₛ=Nᵢₜₑᵣₐₜᵢₒₙₛ+1) (218), and the process returns to 306.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system for predicting financial outcome of an order, the system comprising:
at least one processor;
a non-transitory computer-readable storage medium including instructions executable by the at least one processor, the instructions configured to implement,
a discriminant model training module configured to receive historical orders from a data source, and generate discriminant model parameters based on the historical orders;
a discriminant model engine configured to receive at least one order to be analyzed, and calculate a probability for each of a plurality of outcomes for the at least one order to be analyzed based on the discriminant model parameters; and
a strategy comparison module configured to calculate an expected business value for at least one strategy based on, in part, the probabilities for the plurality of outcomes to evaluate a risk associated with the at least one order.

2. The system of claim 1, wherein the discriminant model training module configured to generate discriminant model parameters based on the historical orders includes:
computing new discriminant model parameters during each iteration based on discriminant model parameters of a previous iteration and a change to the discriminant model parameters from the previous iteration.

3. The system of claim 2, wherein,
the discriminant model training module is configured to calculate the change to the discriminant model parameters from the previous iteration includes calculating a negative log likelihood based on, in part, the historical orders, and calculating the change to the discriminant model parameters based on, in part, a function of a gradient of the negative log likelihood,
the discriminant model training module is configured to output the new discriminant model parameters to the discriminant model engine when a current iteration exceeds a maximum iteration or a change in the negative log likelihood from the previous iteration is less than a threshold value.

4. The system of claim 1, wherein the discriminant model engine configured to calculate a probability for each of a plurality of outcomes for the at least one order to be analyzed based on the discriminant model parameters includes:
calculating a probability that the order to be analyzed belongs to each of the plurality of outcomes based on a function corresponding to each outcome supplied with the discriminant model parameters and a feature vector representing one or more attributes of the at least one order to be analyzed.

5. The system of claim 1, wherein the strategy comparison module configured to calculate an expected business value for at least one strategy based on, in part, the probabilities for the plurality of outcomes includes:
calculating an expected business value for each outcome based on a projected business value and the probability associated with a respective outcome; and
calculating the expected business value for the at least one strategy based on the calculated expected business value for each outcome.

6. The system of claim 1, wherein the expected business value includes an expected revenue.

7. The system of claim 1, wherein the strategy comparison module is configured to provide the expected business value in conjunction with the at least one strategy for display.

8. The system of claim 1, wherein the strategy comparison module is configured to provide, with respect to each outcome for the at least one strategy, a respective projected business value, a respective probability, and a respective expected business value for display, the respective expected business value being provided based on the respective projected business value and the respective probability.

9. The system of claim 1, wherein each historical order includes a first feature vector representing one or more attributes or features of the historical order, and an outcome vector representing a final outcome of a respective historical order, and the at least one order to be analyzed includes a second feature vector representing one or more attributes or features of the at least one order to be analyzed.

10. The system of claim 9, wherein the first feature vector and the second feature vector include customer-related features including financial status and contribution of revenue, and order attributes including amount and type of products for a respective order.

11. The system of claim 1, wherein the at least one strategy includes acceptance of the order and rejection of the order.

12. The system of claim 1, wherein the plurality of outcomes includes on-time payment, overdue payment, and default payment.

13. The system of claim 1, wherein the at least one order to be analyzed includes a product order for at least one product for which a purchase amount of the at least one product exceeds a credit limit associated with a customer.

14. A non-transitory computer-readable medium storing instructions that when executed cause one or more processors to predict financial outcome of an order, the instructions comprising instructions to:
receive historical orders from a data source;
generate discriminant model parameters based on the historical orders;
receive at least one order to be analyzed;
calculate a probability for each of a plurality of outcomes for the at least one order to be analyzed based on the discriminant model parameters; and
calculate an expected business value for at least one strategy based on, in part, the probabilities for the plurality of outcomes to evaluate a risk associated with the at least one order.

15. The non-transitory computer-readable medium of claim 14, wherein the instructions to generate discriminant model parameters based on the historical orders includes instructions to:
compute new discriminant model parameters during each iteration based on discriminant model parameters of a previous iteration and a change to the discriminant model parameters from the previous iteration.

16. The non-transitory computer-readable medium of claim 15, wherein the instructions include instructions to:
calculate the change to the discriminant model parameters from the previous iteration including calculating a negative log likelihood based on, in part, the historical orders, and calculating the change to the discriminant model parameters based on, in part, a function of a gradient of the negative log likelihood; and
output the new discriminant model parameters when a current iteration exceeds a maximum iteration or a change in the negative log likelihood from the previous iteration is less than a threshold value.

17. The non-transitory computer-readable medium of claim 14, wherein the instructions to calculate a probability for each of a plurality of outcomes for the at least one order to be analyzed based on the discriminant model parameters includes instructions to:
calculate a probability that the order to be analyzed belongs to each of the plurality of outcomes based on a function corresponding to each outcome supplied with the discriminant model parameters and a feature vector representing one or more attributes of the at least one order to be analyzed.

18. The non-transitory computer-readable medium of claim 14, wherein the instructions to calculate an expected business value for at least one strategy based on, in part, the probabilities for the plurality of outcomes to evaluate a risk associated with the at least one orders includes instructions to:
calculate an expected business value for each outcome based on a projected business value and the probability associated with a respective outcome; and
calculate the expected business value for the at least one strategy based on the calculated expected business value for each outcome.

19. The non-transitory computer-readable medium of claim 14, wherein the expected business value includes an expected revenue.

20. A method for predicting financial outcome of an order performed by at least one processor, the method comprising:
receiving, including the at least one processor, historical orders from a data source;
generating, including the at least one processor, discriminant model parameters based on the historical orders;
receiving, including the at least one processor, at least one order to be analyzed;
calculating, including the at least one processor, a probability for each of a plurality of outcomes for the at least one order to be analyzed based on the discriminant model parameters; and
calculating, including the at least one processor, an expected business value for at least one strategy based on, in part, the probabilities for the plurality of outcomes to evaluate a risk associated with the at least one order.
